(19) United States
(12) Patent Application Publication
(10) Pub. No.: US 2020/0205424 A1
(43) Pub. Date: Jul. 2, 2020

(54) Potato Dough

(71) Applicant: LambWeston / Meijer V.O.F., Kruiningen (NL)

(72) Inventors: Sjoerd Van Gent, Rotterdam (NL); Bart Donders, Kapelle (NL)

(21) Appl. No.: 16/646,800

(22) PCT Filed: Sep. 14, 2018
(86) PCT No.: PCT/EP2018/074963

§ 371 Date: Mar. 12, 2020

(30) Foreign Application Priority Data
Sep. 14, 2017 (NL) 2019547

(51) Int. Cl. A21D 13/043; A21D 2/18; A21D 2/26; A21D 10/00; A21D 13/43; A23L 19/18

(52) U.S. Cl. CPC A21D 13/043; A21D 2/186; A21D 2/264; A21D 13/31; A21D 13/43; A23L 19/19; A21D 10/005

(57) ABSTRACT

The present invention relates to a dry mix for the preparation of a potato-based dough or batter, comprising dehydrated potato, starch, protein and optionally amylopectin and a sugar. The dehydrated potato is in the form of flakes or granules and constitutes more than 50% of the dry mix, preferably at least 95%. The invention further relates to a batter and a dough prepared from the dry mix and for use in the preparation of a food product such as churros, fritters, waffles, donuts, beignets, empanadas, quesadillas, pancakes, crêpes, blinis, pizzas, flatbread, steamed buns, roti, chapatti, tortillas, parathas, flammkuchen, muffins, scones, filled pockets, filled sticks, finger food, dumplings.

The present invention relates to a dough or batter that is based on potato. The invention further relates to a dry mix for preparing the batter or dough, to food products prepared from the batter or dough and to a method for preparing the food products.

Dough is a thick, malleable, sometimes elastic, paste made out of flour from grains, legumes or nuts. Batter is thin dough that is used in different applications. Batter is used mainly for pancakes, light cakes, and as a coating for fried foods. Dough is typically made by mixing flour with a small amount of water and/or other liquid, and sometimes includes yeast or other leavening agents as well as other ingredients such as various fats or flavorings. The flours that are commonly used in doughs and batters, are often made from wheat but also flours made from maize, rice, and cereals and other crops are used.

Most doughs have viscoelastic properties. This is often the result of gluten which gives elasticity to dough, helping it rise and keep its shape and often gives the final product a chewy texture. Gluten comprise proteins, such as prolamins and glutelins, that are stored together with starch in the endosperm of various grass-related grains. It is found in wheat, barley, rye, oat, related species and hybrids, such as spelt.

A small pail of the general population is hypersensitive to gluten, which can trigger coeliac disease and other gluten-related disorders. These people cannot eat food products prepared from gluten-containing doughs and batters. It is therefore desirable to have alternatives that have the same or similar mouth-feel and the same cooking characteristics.

It is therefore an object of the present invention to provide an alternative type of dough that can be used for the preparation of food products that are also suitable for use in a gluten-free diet.

In the research that led to the present invention it was found that it is possible to prepare a versatile dough based on potato, that can be mechanically processed and is extendable. Potato is gluten-free and can thus be part of the diet of gluten-intolerant people.

The present invention thus relates to a dry mix for the preparation of a potato-based dough or batter, comprising dehydrated potato, starch, protein and optionally amylopectin and a sugar. A dry mix has a much longer shelf-life than wet preparations.

Dehydrated potato is prepared according to well known processes. In summary, raw potato pieces are steam cooked, mashed, dried and comminuted into flakes or granules. Both for forms can be used in the dry mix of the invention. Dehydrated potato flakes or granules thus comprise all the ingredients already present in the raw potato and optionally in addition a processing aid, such as an emulsifier. Freshly harvested, potato contains about 80 percent water and about 20 percent dry matter. About 60 to 80 percent of the dry matter is starch. In addition, the potato contains protein and is low in fat. Potatoes are rich in several micronutrients, especially vitamin C. They also contain iron, vitamins B1, B3 and B6 and minerals such as potassium, phosphorus and magnesium, and contains folate, pantothenic acid and riboflavin. Potatoes also contain dietary antioxidants. The dehydrated potato used in the present invention is suitably made from raw potato and contains all its constituents. Suitably, the dehydrated potato constitutes more than 50% of the dry mix. In a preferred embodiment the potato content of the dehydrated potato is at least 95%. In an even more preferred embodiment the dehydrated potato is made from fresh potato. The advantage there of is that it still comprises an amount of native starch. The combination of native and heat treated starch in the potato flakes contributes to the viscosity and elasticity of the dough. In addition, it provides the dough or batter with a good moisture balance.

The dry mix of the invention further comprises a starch. The starch is added to the mix in addition to the starch that originates from the dehydrated potato. In a preferred embodiment, the starch is at least partially, preferably completely formed by potato starch. The starch can either be native starch or modified starch or combinations thereof.

As a further ingredient the dry mix comprises a protein. The protein is added to the mix in addition to the protein that originates from the dehydrated potato. Preferably the protein is a potato protein, in particular a native potato protein. Native potato proteins can be divided into the following three classes: (i) the patatin family, highly homologous acidic 43 kDa glycoproteins (40-50 wt. % of the potato proteins), (ii) basic 5-25 kDa protease inhibitors (30-40 wt. % of the potato proteins) and (iii) other proteins, mostly high molecular weight (HMW) proteins (10-20 wt. % of the potato proteins).

The protein that is added to the mix has preferably not been heat-treated and is thus not inactivated. This is different from the protein present in the dehydrated potato flakes or granules. These proteins underwent a heat treatment during production of the flakes. The added protein is thus preferably a native, protein with functionality in dough and baking properties.

The native potato proteins are mainly formed by patatin, protease inhibitors and HMW proteins. These proteins are in particular useful in the dry mix of the invention and are thus a preferred ingredient. It is found that the addition of potato proteins provides the dough of the invention with the ability to be mechanically processed, makes it extendable and contributes to the viscoelastic properties of the dough of the invention.

The dry mix of the invention also comprises amylopectin. The amylopectin is added to the mix in addition to the amylopectin that originates from the dehydrated potato. The source of amylopectin is preferably an amylopectin-rich potato starch. An amylopectin-rich potato starch comprises at least 70%, preferably at least 85%, more preferably 100% amylopectin. The amylopectin is involved in the moisture control of the dough.

The dry mix of the invention preferably also comprises a sugar but this ingredient is optional. The sugar is added to the mix in addition to the sugar that originates from the dehydrated potato. Suitably, the sugar is dextrose monohydrate, and preferably it is potato dextrose monohydrate. Alternatively, the dextrose originates from a source other than potato, such as corn or rice. The sugar is add for obtaining a nice golden-brown color after baking or frying and confers crispiness to the end product.

In addition to the above ingredients, the dry mix may further comprise one or more additional ingredients selected from salt, flavorings, coloring agents, seasoning, spices, eggs.

The dry mix of the present invention preferably comprises at least 90%, preferably 92%, more preferably 95% potato ingredients. This will for example be the case when the mix also contains salt which is inherently not potato-based and dextrose from another source, such as corn or rice. Even more preferably, at least 98% of the ingredients originate from potato. This will for example be the case when the mix also contains salt which is inherently not potato-based. Most preferably, the dry mix is completely potato-based. The advantage of an almost completely potato-based product is that it will not contain traces of gluten. Furthermore, the fried or baked product will be crispy on the outside and soft, like puree, on the inside leading to an attractive mouth-feel.

In one embodiment the dry mix of the invention comprises:

40-70%, in particular 50-60% dehydrated potato;

15-40%, in particular 20-35% starch;

3-12%, in particular 5-10% protein;

1-10%, in particular 2-6% amylopectin;

optionally 1-5%, in particular 2-4% sugar; and

optionally 0.5-3.5%, in particular 1-3% salt.

In one particular embodiment, the dry mix comprises:

about 57% dehydrated potato;

about 28% potato starch;

about 7% potato protein;

about 3% amylopectin-rich potato starch;

about 3% monohydrate potato dextrose; and

about 2% salt.

According to a further aspect thereof the invention relates to batters and doughs prepared from the dry mix. The dough or batter is produced by mixing the dry mix with a liquid. The difference between batters and doughs is the amount of added liquid. As used herein the te “batter” refers to a product that needs to be deposited or piped. The term “dough” refers to all other consistencies.

The liquid used in the batter and dough preparations can be any liquid but is preferably selected from water, oil, fat, in particular baking fat, butter, egg or combinations thereof. The various liquids can confer different characteristics to the end product. Coconut oil leads for example to the formation of more crust, whereas butter provides a more creamy and smooth texture.

The invention in particular relates to a batter preparation for producing baked or fried food products, comprising the dry mix as described above and a liquid, wherein for 100% dry mix 180-220%, in particular 200% liquid is added.

Batter preparations are a bit more viscous than doughs and can be piped, extruded or deposited in a baking form. Extrusion is a process by which a mixture of ingredients is forced through an opening in a perforated plate or die with a particular design, and is then cut to a specified size. The extrusion process usually already involves partial cooking of the food product. Piping relates to squeezing the raw batter trough the particularly designed nozzle of a piping bag or machine. Batters are in particular useful in the production of churros, fritters, waffles, filled sticks, donuts and beignets.

In another embodiment, the invention relates to a dough preparation for producing baked or fried food products, comprising the dry mix and a liquid, wherein for 100% dry mix 110-150%, in particular 130% liquid is added.

Dough preparations can be used processed in various ways, such as kneading, rolling and shaping. Doughs are suitable for the production of empanadas, quesadillas, pancakes, crêpes, blinis, pizzas, flatbread, steamed buns, roti, chapatti, tortillas, parathas, filled sticks, donuts, waffles, beignets.

According to the further aspect thereof, the invention relates to food products prepared from a batter or a dough preparation described above.

The batter and dough of the invention are very versatile and can be used for preparing all sorts of baked and fried food products, such as churros, fritters, waffles, donuts, beignets, empanadas, quesadillas, pancakes, crêpes, blinis, pizzas, flatbread, steamed buns, roti, chapatti, tortillas, parathas, flammkuchen, muffins, scones, filled pockets, finger food, filled sticks, such as cheese sticks, dumplings. The food products can have a sweet or savory taste depending on the additional ingredients that are added to the dry mix or to the batter or dough. Food products may themselves be filled with sweet or savory fillings, such as empanadas, beignets, steamed buns and (cheese) sticks.

The food products are in general crispy on the outside with a smooth and fluffy interior. Products made from naturel batter or dough have a potato taste. In other products the taste can be adapted by the addition of sweet and savory additives. The product can be colored with natural food colors, such as saffron water, tomato juice, beet juice, carrot juice etc.

According to the invention various commercial forms can be envisaged. One suitable commercial product is the dry mix which has a long shelf-life and can according to ones need be combined with a desired liquid and other ingredients. Other products made with the dry mix, such as the prepared batter or dough and semi-finished and finished products are also part of this invention. The batter, dough and the semi-finished products may for example also be provided in frozen form. The same applies to the finished product.

The present invention also relates to a method for preparing a food product, comprising the steps of:

a) shaping the batter preparation or the dough preparation of the invention into a semi-finished food product; and

b) cooking the semi-finished food product to obtain the finished food product.

The batter and dough can be shaped with a variety of shaping techniques, in particular kneading, forming, rolling out, extruding, filling, depositing in a baking mold, die-cutting, sheet-forming, molding, piping.

The end product, i.e. the finished food product can be obtained by means of various cooking methods, such as baking, frying, deep-frying, etc. Suitably, the cooking is performed in an oven, such as an impingement oven or a convectional oven, in a frying pan, an air-fryer, a waffle iron, churrera, deep-fryer, hot plate, etc.

The present invention will be further illustrated in the Examples that follow and that are not intended to limit the invention in any way. In the Examples reference is made to the following figures:

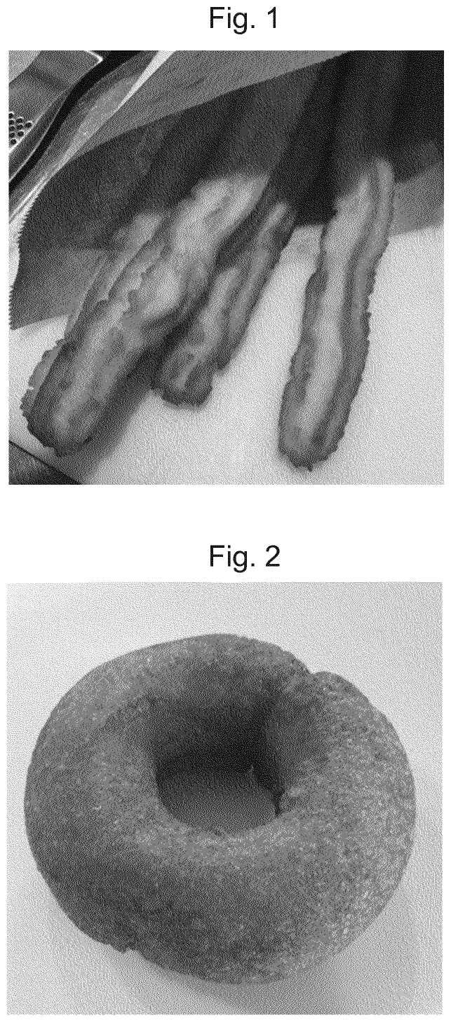

FIG. 1: Churros prepared from a batter of the invention.

FIG. 2: Donut prepared from a batter of the invention.

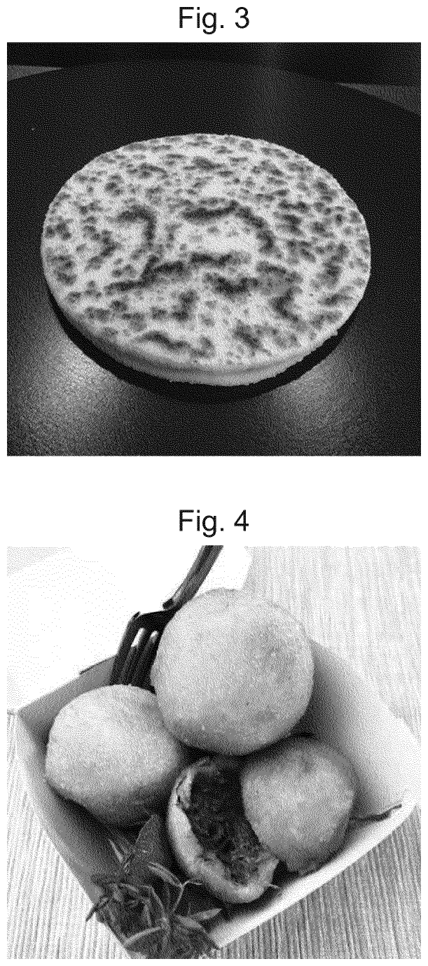

FIG. 3: Flatbread prepared from a dough of the invention.

FIG. 4: Filled balls of the invention.

### EXAMPLES

### Example 1

### Preparation of the Dry Mix

For the preparation of the dry mix the following ingredients were mixed in dry form:

57% dehydrated potato;

28% potato starch;

7% potato protein;

3% amylopectin-rich potato starch;

3% monohydrate potato dextrose; and

2% salt.

This dry mix is used as the starting material for the preparation of various products.

### Example 2

### Preparation of Churros

Three eggs and 600 g water were mixed in a mixer. Subsequently, 350 g of the dry mix prepared in Example 1 was added bit by bit. After the batter was formed 50 g melted butter was added. A churrera was used to shape the churros which were then deep-fried for a few minutes. The resulting churros are shown in FIG. 1.

### Example 3

### Preparation of Donuts

Three eggs and 600 g water were mixed in a mixer. Subsequently, 350 g of the dry mix prepared in Example 1 was added bit by bit. After the batter was formed 50 g melted butter was added. A piping bag with a round nozzle was used to deposit the batter in a silicone donut mold. Initially, only half of the mold is filled. After adding an optional filling to the batter in the mold, the other half of the mold is filled with the remaining batter. After freezing the donuts are deep-fried for a few minutes. FIG. 2 shows the finished donut.

### Example 4

### Preparation of a Flatbread

Water (530 g) was added to the mixing bowl of a mixer. 420 g of the dry mix was added bit by bit while the mixer was operating. After formation of the dough, 50 g melted butter was added to and distributed through the dough in the mixing bowl. Subsequently, the dough was kneaded by hand and rolled out to form dough slabs with a thickness of 5 mm. After optionally freezing the slabs they are baked on a crêpe maker. FIG. 3 shows the baked product.

For a filled version of the flatbread the first slab was baked and then the filling was put on the baked slab. A second slab of dough was then put on top and the so obtained sandwich was turned around to bake the second dough slab until golden brown.

### Example 5

### Preparation of Filled Balls

Four eggs and 825 g water were a mixed in a mixer. Subsequently, 750 g of the dry mix was added. After formation of the dough 75 g melted butter was added. The thus obtained dough was rolled out to a thickness of 4-5 mm. Circles were cut out of the dough. A frozen ball of filling was put on the dough circles and a second circle was put on top. After forming the balls by hand, the filled balls were deep-fried for a few minutes. FIG. 4 shows the resulting product.

1. Dry mix for the preparation of a potato-based dough or batter, comprising dehydrated potato, added starch, added potato protein and optionally amylopectin and a sugar.

2. The dry mix as claimed in claim 1, wherein the dehydrated potato is in the form of flakes or granules.

3. The dry mix as claimed in claim 1, wherein the dehydrated potato constitutes more than 50% of the dry mix.

4. The dry mix as claimed in claim 1, wherein the potato content of the dehydrated potato is at least 95%.

5. The dry mix as claimed in claim 1, wherein the starch is at least partially, preferably completely formed by potato starch.

6. The dry mix as claimed in claim 1, wherein the potato protein is a native potato protein.

7. The dry mix as claimed in claim 6, wherein the native potato protein comprises patatin and/or protease inhibitors and/or high molecular weight (HMW) proteins.

8. The dry mix as claimed in claim 1, wherein the amylopectin comprises amylopectin-rich potato starch.

9. The dry mix as claimed in claim 1, wherein the sugar is dextrose monohydrate, in particular potato dextrose monohydrate.

10. The dry mix as claimed in claim 1, further comprising one or more additional ingredients selected from salt, flavorings, coloring agents, seasoning, spices, eggs.

11. The dry mix as claimed in claim 1, comprising:
40-70% dehydrated potato;
15-40%, starch;
3-12% protein;
1-10% amylopectin;
optionally 1-5% sugar; and
optionally 0.5-3.5% salt.

12. The dry mix as claimed in claim 11, comprising:
about 57% dehydrated potato;
about 28% potato starch;
about 7% potato protein;
about 3% amylopectin-rich potato starch;
about 3% monohydrate potato dextrose; and
about 2% salt.

13. The dry mix as claimed in claim 1, wherein at least 90%, of the ingredients originates from potato.

14. Batter preparation for producing baked or fried food products, comprising the dry mix as claimed in claim 1 and a liquid, wherein for 100% dry mix 180-220% liquid is added.

15. Batter preparation as claimed in claim 14, wherein the liquid is selected from water, oil, baking fat, butter, eggs or combinations thereof.

16. Use of the batter preparation as claimed in claim 14, in the production of churros, fritters, waffles, donuts, beignets, filled stick.

17. Dough preparation for producing baked or fried food products, comprising the dry mix as claimed in claim 1 and a liquid, wherein for 100% dry mix 110-150% liquid is added.

18. Dough preparation as claimed in claim 17, wherein the liquid is selected from water, oil, fat, in particular baking fat, butter, eggs or combinations thereof.

19. Use of the dough preparation as claimed in claim 17, for use in the production of empanadas, quesadillas, pancakes, crêpes, blinis, pizzas, flatbread, steamed buns, roti, chapatti, tortillas, parathas, filled sticks, waffles, donuts, beignets.

20. Food product prepared from a batter preparation or a dough preparation comprising the dry mix as claimed in claim 1 and a liquid.

21. Food product as claimed in claim 20, wherein the food product is selected from churros, fritters, waffles, donuts, beignets, empanadas, quesadillas, pancakes, crêpes, blinis, pizzas, flatbread, steamed buns, roti, chapatti, tortillas, parathas, flammkuchen, muffins, scones, filled pockets, filled sticks, finger food, dumplings.

22. Method for preparing a food product as claimed in claim 21, comprising
a) shaping the batter preparation or the dough preparation into a semi-finished food product; and
b) cooking the semi-finished food product to obtain the finished food product.

23. The method as claimed in claim 22, wherein shaping the batter preparation comprises kneading, forming, rolling out, extruding, filling, depositing in a baking mold, die-cutting, sheet-forming, molding, piping.

24. The method as claimed in claim 23, wherein cooking comprises baking, frying, deep-frying.

25. The method as claimed in claim 22, wherein the cooking is performed in an oven, a frying pan, an airfryer, a waffle iron, a deep-fryer, hot plate.
